(19) United States
(12) Patent Application Publication
(10) Pub. No.: US 2015/0221034 A1
(43) Pub. Date: Aug. 6, 2015

(54) Pricing a Swap Financial Product Using a Non-Par Value

(71) Applicant: Chicago Mercantile Exchange Inc., Chicago, IL (US)

(72) Inventors: John Nyhoff, Darien, IL (US); Frederick Sturm, Chicago, IL (US); John Labuszewski, Westmont, IL (US)

(21) Appl. No.: 14/689,420

(22) Filed: Apr. 17, 2015

Related U.S. Application Data
(63) Continuation of application No. 13/209,070, filed on Aug. 12, 2011.

(51) Int. Cl. G06Q 40/04

(52) U.S. Cl. CPC G06Q 40/04

(57) ABSTRACT

Computer readable media, methods, and apparatuses may be configured for processing a plurality of yields, each of the yields corresponding to a different maturity date, determining a plurality of floating payments based on the yields, determining a plurality of fixed payments based on a fixed interest rate, determining a present value of the floating payments, determining a present value of the fixed payments, and generating a quote for a swap financial product as a function of the present value of the floating payments and the present value of the fixed payments.

### CROSS-REFERENCE TO RELATED APPLICATION

This application is a continuation of U.S. patent application Ser. No. 13/209,070, titled “Pricing a Swap Financial Product using a Non-Par value” and filed Aug. 12, 2011. Application Ser. No. 13/209,070, in its entirety, is incorporated by reference herein.

### BACKGROUND INFORMATION

Swaps are often used to hedge certain risks, for instance, interest rate risk, but can also be used for speculative purposes. An interest rate swap (IRS) is an example of a type of swap product where the parties agree to exchange streams of future interest payments based on a specified principal or notional amount. Each stream may be referred to as a leg. When an IRS occurs at “par value,” no money changes hands between the counterparties, at the inception of the swap transaction, because the net present value (NPV) of the fixed and floating rates are equal at the time of the trade.

An example of a swap includes a plain fixed versus floating, or “vanilla,” interest rate swap. The vanilla swap includes an exchange of interest streams where one stream is based on a floating rate and the other interest stream is based on a fixed rate. In a vanilla swap, one party makes periodic interest payments to the other based on a variable interest rate, subject to periodic resets. The variable rate may be linked to a periodically known or agreed upon rate for the term of the swap such as the London Interbank Offered Rate (LIBOR) or the British Banker's Association (BBA) 3-month time deposit rate.

In return for the stream of payments based on the variable rate, the other party may receive periodic interest payments based on a fixed rate. The payments are calculated based on a designated notional amount. The first rate is called variable, because it is reset at the beginning of each interest calculation period to the then current reference rate, such as the LIBOR published rate. The counterparties may use an IRS to limit, or manage, exposure to fluctuations in interest rates, and/or to obtain lower interest rates than are otherwise available. Other examples of swaps include total return swaps, and equity swaps.

A total return swap (also known as total rate of return swap, or TRORS) is a swap where one party receives periodic income (e.g., interest or dividend payments) based on an underlying asset (plus any capital gains/losses) over the holding period, while the other receives a specified fixed or floating cash flow. The total return is the capital gain or loss, plus any interest or dividend payments. The specified fixed or floating cash flow is typically unrelated to the credit worthiness of the reference asset. The underlying asset may be any asset, index, or basket of assets. The total return receiving party gains exposure to the return of the underlying asset, without having to actually hold the asset. That is, one party gains the economic benefit of owning an asset without having the asset on its balance sheet, while the other (which does retain that asset on its balance sheet) has protection against a potential decline in its value. An equity swap is a variation of a total return swap. The underlying asset in an equity swap may be a stock, a basket of stocks, or a stock index.

Currently, financial institutions such as banks trade interest rate payments and/or interest rate swaps over the counter (OTC). Steams of future payments must be valued to determine a current market price at the time of the trade. Complicating the determination of the current market price is that interest rate swaps often have unique terms specified by the parties. These unique terms contribute to an IRS having less liquidity than desired. To determine a current price, the terms of the IRS must be reviewed to assess a present value of the counterparties' interest in the IRS. The time and effort required to assess the unique terms and to determine the present value contributes to reducing liquidity of the IRS. Such liquidity issues have limited trading of interest rate swaps to OTC markets. Therefore, improved financial instruments are needed.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Computer readable media, methods, and apparatuses may be configured for processing a plurality of yields, each of the yields corresponding to a different maturity date, determining a plurality of floating payments based on the yields, determining a plurality of fixed payments based on a fixed interest rate, determining a present value of the floating payments, determining a present value of the fixed payments, and generating a quote for a swap financial product as a function of the present value of the floating payments and the present value of the fixed payments.

In some embodiments, aspects of the example embodiments may be implemented on a computer-readable medium, for example, by storing computer-executable instructions or modules, or by utilizing computer-readable data structures. The computer readable medium may be non-transitory and/or may be a memory. In an example, one or more computer readable media may store computer-executable instructions that, when executed by at least one processor, cause at least one apparatus to perform the operations described herein.

In some embodiments, aspects of the example embodiments may be implemented on a computer-readable medium, for example, by storing computer-executable instructions or modules, or by utilizing computer-readable data structures. The computer readable medium may be non-transitory and/or may be a memory. The example embodiments may also include additional elements, steps, computer-executable instructions, or computer-readable data structures. For example, one skilled in the art will recognize that the various modules described herein may be implemented using programming code (e.g., C++, C, Java, etc.) and be associated with a processor on a computing device that may execute the module. The programming code may include common elements of software programming, such as “for loops”, “do-while loops”, function calls, if-else syntax, “switch” syntax, and other well known elements. While programming code has not been provided for each of the various modules, one skilled in the art after review of the entirety disclosed herein will appreciate that such programming code may be authored without requiring undue experimentation.

Numerous embodiments are disclosed and claimed herein. The details of these and other embodiments are set forth in the accompanying drawings and the description below. Other features and advantages will be apparent from the description and drawings, and from the claims.

### BRIEF DESCRIPTION OF THE DRAWINGS

Aspects of the disclosure may take physical form in certain parts and steps, embodiments of which will be described in detail in the following description and illustrated in the accompanying drawings that form a part hereof, wherein:

FIG. 1 depicts an illustrative operating environment that may be used to implement various aspects of the disclosure, in accordance with example embodiments.

FIG. 2 illustrates a table including example market data corresponding to a 2 year Eurodollar Swap Index futures contract having a 1% coupon and $1 million Notional value, in accordance with example embodiments.

FIG. 3 illustrates a table for determining the value of a quote for a swap index futures contract in accordance with example embodiments.

FIG. 4 illustrates example standardized terms of 2 and 5 year Eurodollar Swap Index Futures contracts in accordance with example embodiments.

FIG. 5 illustrates an example flow diagram of a method for generating a quote for a swap index financial product, in accordance with example embodiments.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

The present disclosure generally relates to systems and methods that are utilized in connection with the electronic trading of interest rate swap (IRS) futures. The example embodiments may be an improvement over existing swap products at least for associating an IRS with existing liquid futures contracts on which the swap may rely for liquidity. CME Eurodollar futures contracts, for example, are very liquid and may be used as the basis for pricing interest rate swap (IRS) futures.

As described in further detail below, the example embodiments may create a swap index futures contract configured as a swap between a series of fixed rate payments and a series of floating rate payments. The floating rate payments may be determined based on yields associated with a sufficiently liquid financial instrument (e.g., Eurodollar futures), and the fixed rate payments may be calculated on the basis of an (arbitrary) fixed coupon.

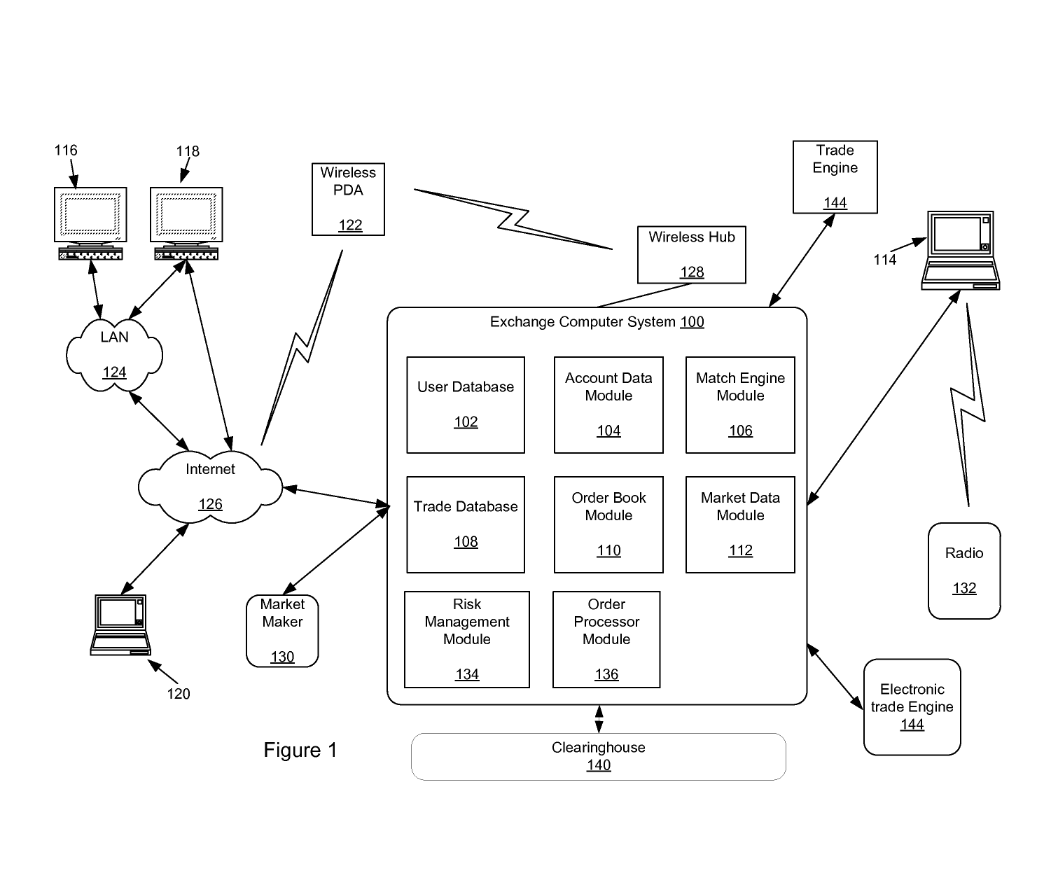

FIG. 1 depicts an illustrative operating environment that may be used to implement various aspects of the disclosure. The operating environment is only one example of a suitable operating environment and is not intended to suggest any limitation as to the scope of use or functionality of the disclosure. Aspects of the present disclosure are implemented with computing devices and networks for exchanging, transmitting communicating, administering, managing and facilitating trading information. An exchange computer system 100 may receive market data, analyze historical data, and/or calculate various values, in accordance with aspects of the disclosure.

Exchange computer system 100 may be implemented with one or more mainframes, servers, gateways, controllers, desktops or other computers. The exchange computer system 100 may include one or more modules, processors, databases, mainframes, desktops, notebooks, tablet PCs, handhelds, personal digital assistants, smartphones, gateways, and/or other components, such as those illustrated in FIG. 1. Moreover, exchange computer system 100 may include one or more processors (e.g., Intel® microprocessor, AMD® microprocessor, RISC processor, a 64-bit processor, etc.) and one or more memories (e.g., solid state, DRAM, SRAM, ROM, Flash, non-volatile memory, hard drive, registers, buffers, etc.)

In addition, an electronic trade engine 144, such as the Globex® trading system, may be associated with an exchange computer system 100. In such an embodiment, the electronic trade engine 144 may include a combination of globally distributed computers, controllers, servers, networks, gateways, routers, databases, memory, and other electronic data processing and routing devices. One skilled in the art will appreciate that numerous additional computers and systems may be coupled (i.e., in operative communication) to exchange computer system 100. Such computers and systems may include clearing, regulatory and fee systems, such as clearinghouse 140. The electronic trade engine 144 may include a trading system interface having devices configured to route incoming messages to an appropriate devices associated with the trading system. The trading system interface may include computers, controllers, networks, gateways, routers and other electronic data processing and routing devices. Orders that are placed with or submitted to the trading system are received at the trading system interface. The trading system interface may route the order to an appropriate device. An exchange computer system 100 may receive orders and transmit market data related to orders and trades to users. In another example, the trade engine 144 may be configured to process orders for instruments associated with another exchange or third party electronic trade matching system.

A user database 102 may include information identifying traders and other users of exchange computer system 100. Such information may include user names and passwords. A trader operating an electronic device (e.g., computer devices 114, 116, 118, 120 and 122) interacting with the exchange computer system 100 may be authenticated against user names and passwords stored in the user database 102. Furthermore, an account data module 104 may process account information that may be used during trades. The account information may be specific to the particular trader (or user) of an electronic device interacting with the exchange computer system 100.

A match engine module 106 may match bid and offer prices for orders configured in accordance with aspects of the disclosure. Match engine module 106 may be implemented with software that executes one or more algorithms for matching bids and offers for financial instruments in accordance with aspects of the disclosure. The match engine module 106 and trading system interface may be separate and distinct modules or component or may be unitary parts. Match engine module 106 may be configured to match orders submitted to the trading system. The match engine module 106 may match orders according to currently known or later developed trade matching practices and processes. In an embodiment, bids and orders are matched on price, on a first in, first out (FIFO) basis. The matching algorithm also may match orders on a pro-rata basis or combination of FIFO and pro rata basis. Other processes and/or matching processes may also be employed. The match engine module 106, after executing matching trades, may also report on the last price for a financial instrument.

Moreover, a trade database 108 may be included to store historical information identifying trades and descriptions of trades. In particular, a trade database may store information identifying or associated with the time that an order was executed and the contract price. The trade database 108 may also comprise a storage device configured to store at least part of the orders submitted by electronic devices operated by traders (and/or other users). A confirmation message may be sent when the match engine module 106 finds a match for an order and the order is subsequently executed. The confirmation message may, in some embodiments, be an e-mail message to a trader, an electronic notification in one of various formats, or any other form of generating a notification of an order execution.

Furthermore, an order book module 110 may be included to compute or otherwise determine current bid and offer prices. The order book module 110 may be configured to calculate the price of a financial instrument. Also, a market data module 112 may be included to collect market data and prepare the data for transmission to users. In addition, a risk management module 134 may be included in the exchange computer system 100 to compute and determine the amount of risk associated with a financial product or portfolio of financial products. An order processor module 136 may be included to receive data associated with an order for a financial instrument. The module 136 may decompose delta based and bulk order types for processing by order book module 110 and match engine module 106. The order processor module 136 may be configured to process the data associated with the orders for financial instruments.

The trading network environment shown in FIG. 1 includes computer (i.e., electronic) devices 114, 116, 118, 120 and 122. The computer devices 114, 116, 118, 120 and 122 may include one or more processors, or controllers, that control the overall operation of the computer. The computer devices 114, 116, 118, 120 and 122 may include one or more system buses that connect the processor to one or more components, such as a network card or modem. The computer devices 114, 116, 118, 120 and 122 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a local area network (LAN) 124. LAN 124 may have one or more of the well-known LAN topologies and may use a variety of different protocols, such as Ethernet. Computer devices 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

The operations of computer devices and systems shown in FIG. 1 may be controlled by computer-executable instructions stored on computer-readable storage medium (e.g., a memory, a CD, a DVD, etc.). Embodiments also may take the form of electronic hardware, computer software, firmware, including object and/or source code, and/or combinations thereof. Embodiments may be stored on computer-readable media installed on, deployed by, resident on, invoked by and/or used by one or more data processors (e.g., 64-bit processor), controllers, computers, clients, servers, gateways, networks of computers, and/or any combinations thereof. The computers, servers, gateways, may have one or more controllers configured to execute instructions embodied as computer software. For example, computer device 114 may include computer-executable instructions for receiving information from exchange computer system 100 to cause display of the information to the user.

One or more market makers 130 may maintain a market by providing bid and offer prices for a derivative or security to exchange computer system 100. Exchange computer system 100 may also exchange information with other trade engines, such as trade engine 144.

A clearinghouse 140 enables an exchange computer system 100 to provide contracts with a lower likelihood of default than over-the-counter (OTC) products. A clearinghouse 140 arranges for transactions to be settled and cleared. Clearing is the procedure through which a clearinghouse 140 becomes buyer to each seller of a contract (e.g., futures contract, equities, currencies, interest rate products, etc.), and seller to each buyer, and assumes responsibility for protecting buyer and seller from financial loss by assuring performance on each contract. A clearinghouse 140 may settle trading accounts, clear trades, collect and maintain performance bond funds, regulate delivery and report trading data. In some scenarios an exchange may operate its own clearinghouse 140 through a division of the exchange through which all trades made are confirmed, matched, and settled each day until offset or delivered. Alternatively, one or more other companies may be provided the responsibility of acting as a clearinghouse 140 with the exchange (and possibly other exchanges). An exchange may have one or more clearinghouses associated with the exchange. An exchange may offer firms qualified to clear trades to provide a clearinghouse 140 for the exchange computer system 100. In some instances, these clearing members may be designated into different categories based on the type of commodities they can clear and other factors.

The clearinghouse 140 may establish minimum performance bond (i.e., initial margin) requirements for the products it handles. A customer may be required to deposit a performance bond with the clearinghouse 140 (or designated account) for the purpose of insuring the clearinghouse 140 against loss on open positions. The performance bond helps ensure the financial integrity of brokers, clearinghouses, and exchanges as a whole. If a trader experiences a drop in funds below a designated minimum requirement (e.g. the maintenance margin level), the clearinghouse 140 may issue a margin call requiring a deposit into the margin account to restore the trader's equity. A clearinghouse 140 may charge additional performance bond requirements at the clearinghouse's discretion. For example, if a clearinghouse's potential market exposure grows large relative to the financial resources available to support those exposures, the clearinghouse 140 may issue a margin call.

In another embodiment, the clearinghouse 140 may require a larger performance bond based on a credit check (e.g., an analysis of the credit worthiness, such as using a FICO™ or comparable score, inter alia) of the customer/trader. The credit check may be performed (i.e., initiated) by a computer of the clearinghouse 140 or the exchange computer system 100. In the example where the clearinghouse 140 performs the credit check, the clearinghouse 140 may send a message (e.g., enforcement message) to the exchange computer system 100. If the credit check indicates that a customer/trader is a high risk, the enforcement message may increase the margin requirements of the customer/trader, or otherwise adjust the capabilities/constraints of the customer/trader commensurate with the higher risk. In the example where the exchange computer system 100 initiates the credit check, the exchange computer system 100 may send a message to one or more clearinghouses associated with the exchange computer system 100 to update them on the increased/decreased risk associated with the customer/trader.

In recognition of the desire to promote efficient clearing procedures and to focus on the true intermarket risk exposure of clearinghouses, a cross-margining system may be used. By combining the positions of joint and affiliated clearinghouses in certain broad-based equity index futures and options into a single portfolio, a single performance bond requirement across all markets may be determined. The cross-margining system may greatly enhance the efficiency and financial integrity of the clearing system.

The principal means by which a clearinghouse 140 mitigates the likelihood of default is through mark-to-market (MTM) adjustments. The clearinghouse 140 derives its financial stability in large part by removing debt obligations among market participants as they occur. Through daily MTM adjustments, every contract is debited or credited based on that trading session's gains or losses. For example, as prices move for or against a position, funds flow into or out of the trading account. This cash flow is known as settlement variation or variation margin.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Example Embodiments

The example embodiments discussed herein may improve liquidity of interest rate swaps for automated trading by an exchange. The example embodiments describe a swap index futures contract that is created by indexing an interest rate swap (IRS) to a sufficiently liquid financial instrument. The swap index futures contract may be configured to swap a stream of fixed payments and a stream of floating payments over a time interval. The swap index futures contract may be cash settled at the end of the time interval. For example, the swap index futures contract may be cash settled on a quarterly basis (e.g., on the 1st Monday preceding the 3rd Wednesday of the contract months of March, June, September and December and corresponding with the normal expiration cycle of CME Eurodollar futures contracts).

The swap index futures contract may have standardized terms with the only trading variable being priced to permit automated trading on an exchange, thus avoiding having to individually assess terms of the swap index futures contracts. Traders may submit buy and sell orders for the swap index futures contracts for matching by an exchange computer system 100 or by a computer of another market marker.

In an example embodiment, the swap index futures contract may be a futures contract based on an interest rate swap associated with a stream of fixed rate payments established at a particular fixed rate coupon (e.g., 1%, 2% on an annual basis) and a stream of floating rate payments referenced to a sufficiently liquid financial instrument (e.g., Eurodollar futures contract referenced to a 3 month BBA LIBOR rate). The fixed rate coupon may also be referred to as an interest rate. The fixed coupon rate may be established at or near then current market negotiated swap levels so that the swap index would be in the vicinity of par or 100. In an example, a particular type of IRS is a British Banker's Association (BBA) London Interbank Offered Rate (LIBOR) swap that is priced on the basis of the same BBA LIBOR fixing rate which is referenced as a final settlement value for Eurodollar futures. BBA LIBOR swaps call for periodic payments on International Monetary Market (IMM) dates which are the dates on which Eurodollar futures generally expire. The fixed and floating rate payments may be made between counterparties at the same time (e.g., each quarter) or at different times (e.g., fixed payment paid semi-annually, floating payment paid quarterly).

In an example, the swap index futures contract may have a notional value (e.g., $1,000,000) at a particular coupon (e.g., 1%) that is fixed over a term (e.g., 6 months, 2 years, 5 years, etc.). The term of the swap index futures contract may be of any desired tenor. In an example, swap index futures could include have a termination date of six months to ten years corresponding with the maturities of CME Eurodollar futures contracts. This may permit swap index futures contract holders to auto-roll from a contract with a notional tenor of N quarters (where N is an integer) to a contract with a notional tenor of N−1 quarters.

The exchange computer system 100 may calculate the fixed rate payments based upon multiplying the notional value by the fixed coupon, divided by the number of annual payments. For example, if a coupon is fixed at 1%, then a semi-annual fixed payment would be $5,000 (i.e., $1,000,000*0.01*0.5). In another example, if a coupon is fixed at 1%, then a monthly fixed payment would be $833.33 (i.e., $1,000,000*0.01/12). The fixed and floating payments may be rendered at other time periods, such as, for example, quarterly.

The floating rate payment may be based on a sufficiently liquid financial instrument such as, for example, a Eurodollar futures contract. A Eurodollar futures contract may have a maturity date anywhere from one day to 10 years. Each Eurodollar futures contract may have an implied yield based on a particular maturity date, and each implied yield may vary over time. Short-term interest rates (or yields) tied to other types of financial instruments may also be used, including U.S. Treasury bill rates, Eurodollar rates (i.e., spot rates rather than the implied rates derived from a Eurodollar futures price), Euribor rates, Euro-Sterling rates, Euroyen rates, EuroSwiss rates, commercial paper rates, banker acceptance rates, the U.S. prime rate, etc. Generally, any financial instrument having a yield for different future time horizons may be used. The exchange computer system 100 may calculate the floating rate payments by reference to settlement values and corresponding yields of the sufficiently liquid financial instrument on a final settlement date that occurs periodically (e.g., monthly, quarterly, etc.), as described later in further detail.

The exchange computer system 100 may generate a quote for the swap index futures contract that reflects a present value of the stream of fixed payments relative to a present value of the stream of floating payments. The quote may be a function of a non-par value. The non-par value may be a difference between “par value” for the swap index futures contract (or 100% of par) and the present value (PV) of the series of floating rate payments minus the PV of the series of fixed rate payments. The exchange computer system 100 may determine the non-par value using the following equation:

Non Par Value=PV(Floating Rate Payments)−PV(Fixed Rate Payments) (1)

Where PV(Floating Rate Payments) is the present value of a sum of the floating rate payments over a term (e.g., 2 years) of the swap index futures contract and PV(Fixed Rate Payments) is the present value of the sum of the fixed rate payments over the term.

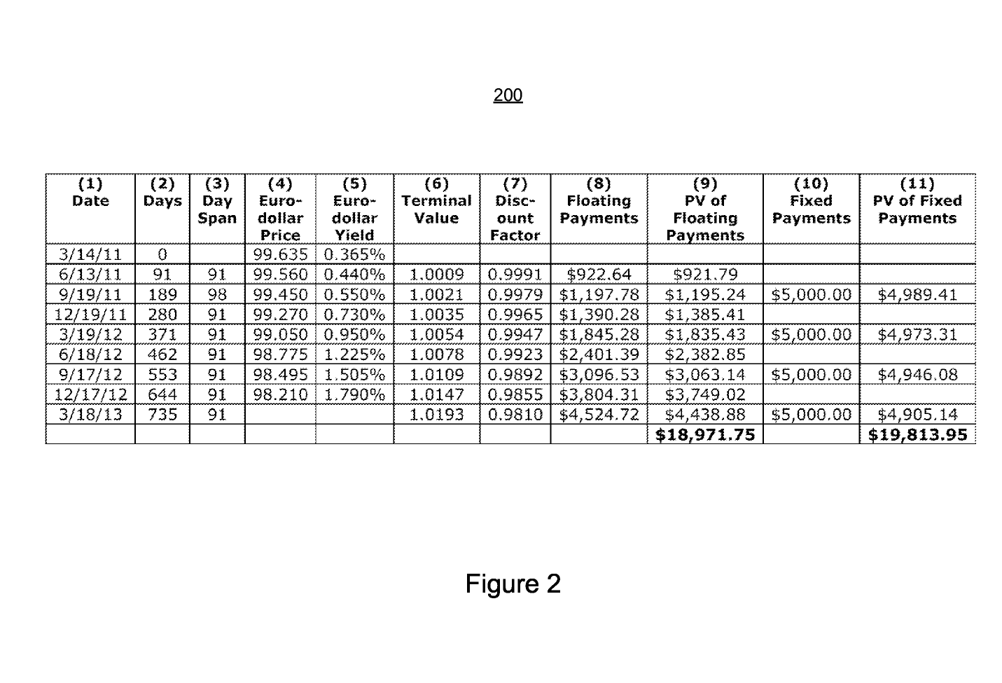

The exchange computer system 100 may determine a quote for a swap index futures contract based on the term of the contract and by reference to yields at a predetermined time for the sufficiently liquid financial instruments over the term, as further described below with reference to FIG. 2. For example, the exchange computer system 100 may determine the quote as a function of floating rate payments associated with a 5-year term by reference to the yield on the next twenty quarterly Eurodollar futures contracts. In another example, the exchange computer system 100 may determine the quote as a function of floating payments associated with a 2-year term by reference to the yield on the next eight quarterly Eurodollar futures contracts. The yield for the sufficiently liquid financial instruments for each of the maturity dates may be obtained from a market data source, such as, for example, CME Globex®.

To determine the quote, the exchange computer system 100 may obtain market data on current settlement prices and/or yields for the sufficiently liquid financial instrument from a market data source, where each of the settlement prices and/or yields correspond to a different maturity date. The following is an example of determining a quote for a swap index futures contract that is configured as a swap between quarterly floating rate payments and semi-annual fixed rate payments over a 2 year term using an actual/360 day count convention and denominated in U.S. dollars (USD).

FIG. 2 illustrates a table corresponding to a 2 year Eurodollar Swap Index futures contract having a 1% coupon and $1 million Notional value. The sufficiently liquid financial instrument may be a Eurodollar futures contract.

Starting on the left, column (1) of table 200 includes final settlement dates of standard quarterly Eurodollar futures contracts. The first date in this calculation of Mar. 14, 2011 represents a final settlement date for the 2 year swap index futures contract. Column (2) lists a day-count between the first date (i.e., in this case Mar. 14, 2011) and any subsequent quarterly date when a floating rate payment is made. For example, the swap index futures contract may have standard terms specifying use of International Swaps and Derivatives Association (ISDA) day-count conventions, affect of holidays and other cash flow, and reset related parameters.

Column (3) lists the number of days between each successive floating rate payment date. For example, there are 91 days between Mar. 14, 2011 and Jun. 13, 2011. Column (4) lists a price of a final settlement value for quarterly Eurodollar futures contracts. For example, the final settlement price for a Eurodollar futures contracts maturing on Mar. 14, 2011 is 99.635, the daily settlement price for a Eurodollar futures contracts maturing on Jun. 13, 2011 is 99.560, and so forth. The exchange computer system 100 may receive the prices in column (4) from a market data source, such as, for example, from CME Globex®.

Column (5) lists the implied yields associated with the Eurodollar futures contracts as 100 minus the Eurodollar Futures Price in column (4). For example, on Mar. 14, 2011, implied yield of the March 2011 Eurodollar futures contract is 100%−99.635%=0.365%. Also, instead of using yields based on Eurodollar futures contracts, the yields in column (5) may be based on implied forward rates related to short-term treasury rates, LIBOR rates, or other manners of providing periodic assessments of yields over time. Implied forward rates may be calculated based on the assumption of zero arbitrage opportunities in interest rate markets. For example, if the 90-day spot LIBOR rate was 1.00% and the 180-day spot Libor rate was 1.50%, then the implied forward rate for a LIBOR based money market instrument (loan or deposit) with a start date=T+90 and a termination date=T=180 ensures that the following condition holds:

[1+R(90)×(90/360)]×[1+IRF(90,180)×90/360]=[1+R(180)×180/360], or [1+1.00%×(90/360)]×[1+IRF(90,180)×90/360]=[1+1.50%×180/360].

This relationship may be rearranged to derive the following expression for the Implied forward rate:

Implied Forward Rate(90,180)=IFR(90,180)=[(1+R(180)×180/360)/(1+R(90)×90/360)−1]×(360/90), or =[(1+1.50%×180/360)/(1+1.00%×90/360)−1]×(360/90)=1.9950%.

Column (6) lists a terminal value referring to a compounded return associated with quarterly Eurodollar yields. For example, investing one dollar at a yield of 0.365% on Mar. 14, 2011 results in a terminal value of $1.0009 at the end of 91 days (i.e., Jun. 13, 2011). The terminal values in column (6) assume that returns are reinvested from quarter to quarter. Continuing the example, investing $1.0009 at 0.440% yield for 98 days results in a terminal value of $1.0021 at the end of the next floating rate period, and so forth.

Column (7) lists a discount factor calculated as a reciprocal of the terminal value in column (6) (i.e., 1/terminal value). For example, the discount factor on Jun. 13, 2011 is 1/1.0009=0.9991. The discount factor may be used to discount a future value back to a present value (e.g., discount the value of each future floating rate payment back to its value on Mar. 14, 2011). Column (8) lists the quarterly floating payments calculated by reference to Eurodollar yield shown in column (5) over the number of days shown in Day Span in column (3) based on using a 360-day count convention for a year. For example, on Jun. 13, 2011, the first floating payment is $922.64=([Eurodollar Yield]*[Day Span]/360)*notional amount=(0.365%*91/360)*$1,000,000.

Column (9) lists the present value of floating rate payments calculated by multiplying the Floating Payment from column (8) by the Discount Factor in column (7). The exchange computer system 100 may discount the floating rate payment to its present value for purposes of calculating the quote for the swap index futures contract. For example, on Mar. 14, 2011, the present value of a floating payment to be paid on Jun. 13, 2011 is $922.64*0.9991=$921.79. It is noted that rounding of the digits in the table slightly affects the calculations.

Column (10) lists the semi-annual fixed payments calculated based upon $1 million notional value for a 1% coupon. In this example, fixed payment=notional amount*coupon value/[number of annual payments]=$1,000,000*0.01*0.5=$5,000. Column (11) lists the present value of fixed rate payments calculated as Fixed Payment (10) multiplied by the discount factor in column (7). The exchange computer system 100 may discount the fixed rate payments discounted to their present value for purposes of calculating the quote for the swap index futures contract. Based on the information in table 200, the exchange computer system 100 may calculate a quote for the swap index futures contract.

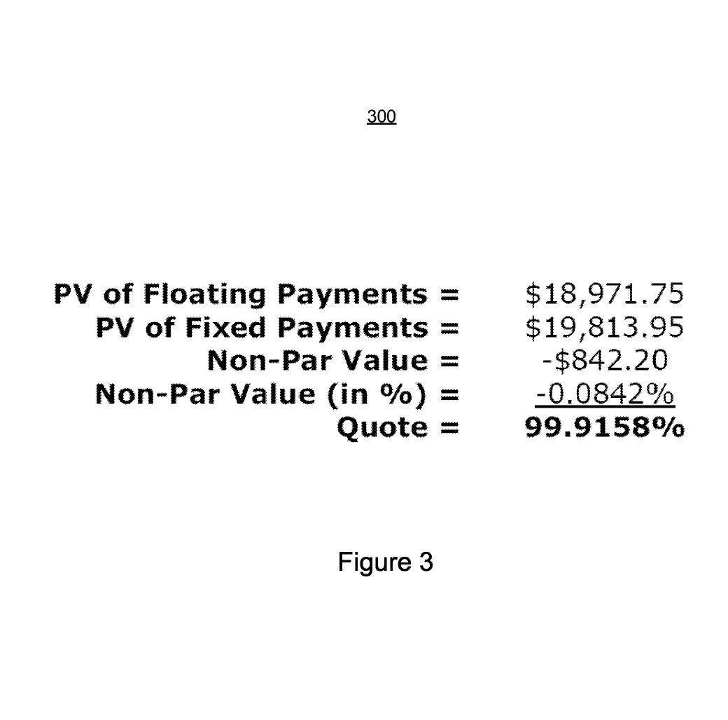

FIG. 3 illustrates a table for determining the value of a quote for a swap index futures contract in accordance with example embodiments. With reference to table 200, the exchange computer system 100 may sum the values in column (9) of table 200 to obtain the present value of the floating payments. In the example of FIG. 3, this is $18,971.75. The exchange computer system 100 may sum the values in column (11) of table 200 to obtain the present value of the fixed payments. In the example of FIG. 3, this is $19,813.95. With reference to equation 1 above, the exchange computer system 100 may determine the non-par value in USD by subtracting the sum of the present value of floating payments from the sum of the present value of fixed payments. In the example of FIG. 3, this is $18,971.75−$19,813.95=−$842.20.

The exchange computer system 100 may subsequently determine the non-par value in terms of percent of par by dividing the non-par value in USD by the notional value. In the example of FIG. 3, this is −$842.20/$1,000,000=−0.0842%. The exchange computer system 100 may provide a quote for the swap index futures contract as 100% of par plus the non-par value in percentage terms. This convention provides a quote for the swap index futures contact that is a positive, and not a negative, number. For example the exchange computer system 100 may determine the quote by adding 100% to the non-par value in percentage terms. In the example of FIG. 3, this is 100%+(−0.0842%)=99.9158%. The quote is as of the final settlement date, which in the example of FIG. 2 is Mar. 14, 2011. The quote may vary over time up the final settlement date.

The quote is in excess of 100% of par when the present value of the floating rate payments exceeds the present value of the fixed rate payments. The quote is less than 100% of par when the present value of the floating rate payments is less than the present value of the fixed rate payments. The quote may permit traders to assess the value of the swap index futures contract and improve liquidity of the IRS futures contract by its association with a sufficiently liquid financial instrument.

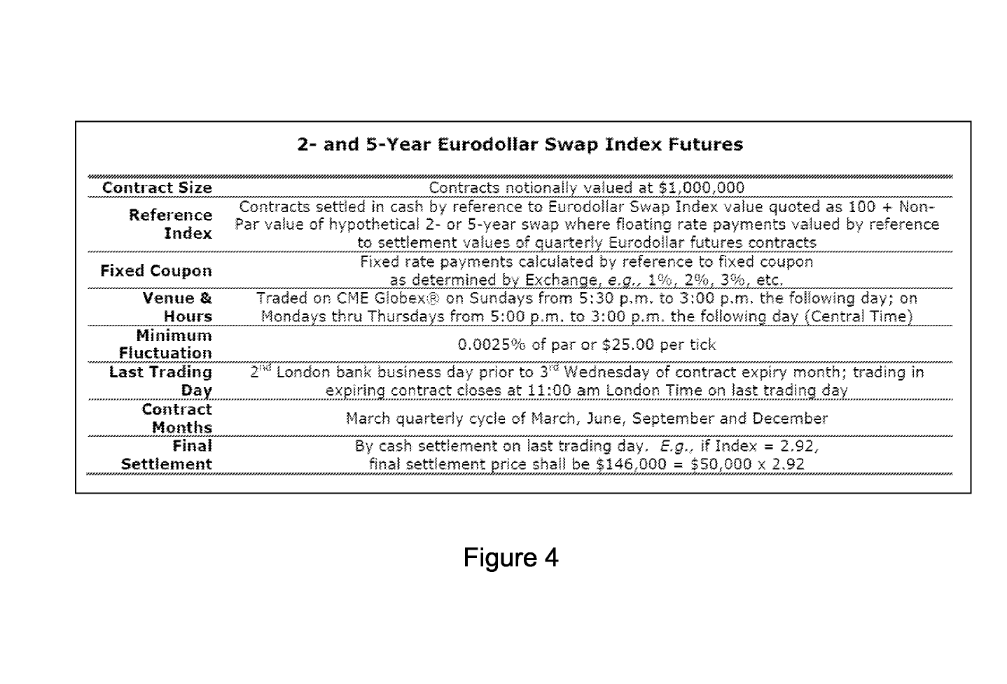

FIG. 4 illustrates example standardized terms of 2 and 5 year Eurodollar Swap Index Futures contracts. Standardized terms may provide for a contract size, a reference index, a fixed coupon, venue & hours, minimum fluctuation, last trading day, contract months, and final settlement. In an example, the swap index futures contract may specify a minimum allowable price fluctuation or tick size (e.g., 0.0025% of par or $25.00 per tick). It is noted that the standard terms provided in FIG. 4 are examples. Other standardized terms may also be used.

The exchange computer system 100 or a computer of another entity may act as a price dissemination device for the swap index futures contract. When acting as a price dissemination device, the exchange computer system 100 may communicate via a network (e.g., Internet 126) a quote for the swap index futures contract to computers of market makers or traders to solicit bids and offers. The exchange computer system 100 may process order messages with bids and/or offers received from computers of one or more traders received in response to the quote. A match engine module 106 of the exchange computer system 100 may match bids and offers that have a common quantity and price to execute a trade for the swap index futures contract. Thus, multiple bids may compete against one another, and multiple offers may compete against one another to execute a trade for the swap index futures contract. Traders may use conventional types of orders (e.g., market orders, limit orders, etc.) when submitting bids and offers.

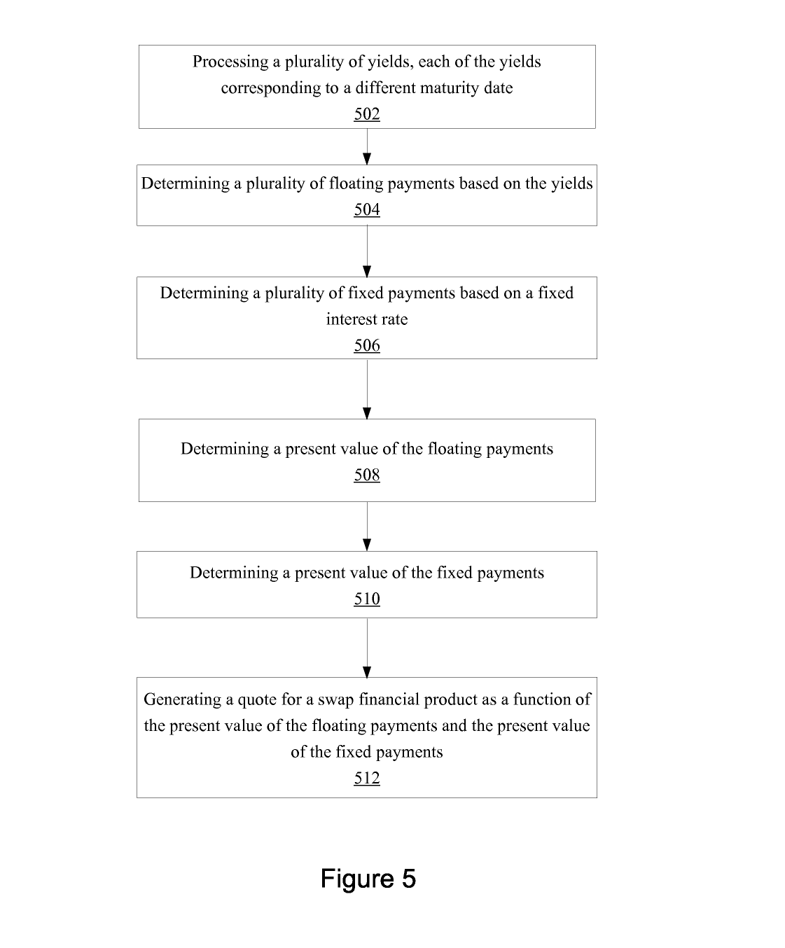

FIG. 5 illustrates an example flow diagram of a method for generating a quote for a swap index financial product. The method may be implemented on a computer, such as, for example, exchange computer system 100. The blocks shown in FIG. 5 may be rearranged, some blocks may be removed, and additional blocks may be added. The flow diagram may begin at block 502.

In block 502, the method may include processing a plurality of yields, each of the yields corresponding to a different maturity date. For example, the exchange computer system 100 may receive market data about yields for Eurodollar futures contracts maturing at different dates, as shown in column (5) of FIG. 2. The exchange computer system 100 may also calculate implied forward rates to determine the yields, may also use yields on U.S. treasuries maturing at different time intervals, or may use other sufficiently liquid financial instruments maturing at different time intervals to determine the yields.

In block 504, the method may include determining a plurality of floating rate payments based on the yields. For example, the exchange computer system 100 may calculate floating rate payments as described above with reference to column (8) of FIG. 2. In block 506, the method may include determining a plurality of fixed payments based on a fixed interest rate. For example, the exchange computer system 100 may calculate fixed rate payments as described above with reference to column (10) of FIG. 2. In block 508, the method may include determining a present value of the floating payments. For example, the exchange computer system 100 may calculate the present value of the floating rate payments as described above with reference to column (9) of FIG. 2.

In block 510, the method may include determining a present value of the fixed payments. For example, the exchange computer system 100 may calculate the present value of the fixed rate payments as described above with reference to column (11) of FIG. 2. In block 512, the method may include generating a quote for a swap financial product as a function of the present value of the floating payments and the present value of the fixed payments. The method may then end.

It is noted that derivatives besides interest rate swaps may also be used when creating the swap index futures contract, including, for example, credit default or other swaps, options, and futures. The example embodiments are contemplated to be useful in connection with any derivative, by which is contemplated any instrument whose value depends on an underlying value.

The present disclosure has been described herein with reference to specific exemplary embodiments thereof. It will be apparent to those skilled in the art that a person understanding this disclosure may conceive of changes or other embodiments or variations, which utilize the principles of this disclosure without departing from the broader spirit and scope of the disclosure as set forth in the appended claims.

1. (canceled)

2. A method comprising:
receiving, by a computer system and from a trading engine computer, and for each of multiple future dates, a current settlement value of a liquid futures contract maturing on that future date;
calculating, by the computer system, a yield corresponding to each of the multiple future dates, each of the yields based on the current settlement value of the futures contract maturing on the future date corresponding to the yield;
determining, by the computer system, a plurality of floating payments, each of the floating payments corresponding to a different one of the future dates and based on the one of the yields corresponding to the one of the future dates immediately preceding the future date corresponding that floating payment;
determining, by the computer system, a plurality of fixed payments based on a fixed interest rate;
determining, by the computer system, a plurality of terminal values, each of the terminal values corresponding to one of the future dates and representing a compounded return based on the yields corresponding to the future dates preceding the future date corresponding to the terminal value;
determining, by the computer system, a discount factor corresponding to each of future dates, each of the discount factors being an inverse of the terminal value corresponding to the same date as the discount factor;
determining, by the computer system, a present value for each of the floating payments, each of the floating payment present values corresponding to one of the future dates and representing the product of the floating payment and the discount factor also corresponding to that future date;
determining, by the computer system, a present value for each of the fixed payments, each of the fixed payment present values corresponding to one of the future dates and representing the product of the fixed payment and the discount factor also corresponding to that future date;
generating, by the computer system, a quote for a swap index futures contract as a function of the present values of the floating payments and the present values of the fixed payments, wherein the swap index futures contract has standard terms and price as the only trading variable;
processing a plurality of bids and a plurality of offers for the swap index futures contract in response to the quote; and
matching at least one of the bids and at least one of the offers to execute a trade for the swap index futures contract.

3. The method of claim 2, wherein the generating comprises determining a sum of the present values of the floating payments, determining a sum of the present values of the fixed payments, and subtracting one of the sums from the other of the sums to obtain a subtraction result, and then subtracting the subtraction result from a fixed value.

4. The method of claim 2, wherein a first of the yields differs from a second of the yields.

5. The method of claim 2, wherein the receiving comprises receiving settlement values for Eurodollar futures contracts maturing on each of the multiple future dates.

6. A computer readable medium storing computer executable instructions that, when executed, cause an apparatus to at least perform:
receiving, from a trading engine computer, and for each of multiple future dates, a current settlement value of a liquid futures contract maturing on that future date;
calculating a yield corresponding to each of the multiple future dates, each of the yields based on the current settlement value of the futures contract maturing on the future date corresponding to the yield;
determining a plurality of floating payments, each of the floating payments corresponding to a different one of the future dates and based on the one of the yields corresponding to the one of the future dates immediately preceding the future date corresponding that floating payment;
determining a plurality of fixed payments based on a fixed interest rate;
determining a plurality of terminal values, each of the terminal values corresponding to one of the future dates and representing a compounded return based on the yields corresponding to the future dates preceding the future date corresponding to the terminal value;
determining a discount factor corresponding to each of future dates, each of the discount factors being an inverse of the terminal value corresponding to the same date as the discount factor;
determining a present value for each of the floating payments, each of the floating payment present values corresponding to one of the future dates and representing the product of the floating payment and the discount factor also corresponding to that future date;
determining a present value for each of the fixed payments, each of the fixed payment present values corresponding to one of the future dates and representing the product of the fixed payment and the discount factor also corresponding to that future date;
generating a quote for a swap index futures contract as a function of the present values of the floating payments and the present values of the fixed payments, wherein the swap index futures contract has standard terms and price as the only trading variable;
processing a plurality of bids and a plurality of offers for the swap index futures contract in response to the quote; and
matching at least one of the bids and at least one of the offers to execute a trade for the swap index futures contract.

7. The computer readable medium of claim 6, wherein the generating comprises determining a sum of the present values of the floating payments, determining a sum of the present values of the fixed payments, and subtracting one of the sums from the other of the sums to obtain a subtraction result, and then subtracting the subtraction result from a fixed value.

8. The computer readable medium of claim 6, wherein a first of the yields differs from a second of the yields.

9. The computer readable medium of claim 6, wherein the receiving comprises receiving settlement values for Eurodollar futures contracts maturing on each of the multiple future dates.

10. An apparatus comprising:
a processor; and
a memory storing computer executable instructions that, when executed, cause the apparatus to at least perform:
receiving, from a trading engine computer, and for each of multiple future dates, a current settlement value of a liquid futures contract maturing on that future date,
calculating a yield corresponding to each of the multiple future dates, each of the yields based on the current settlement value of the futures contract maturing on the future date corresponding to the yield,
determining a plurality of floating payments, each of the floating payments corresponding to a different one of the future dates and based on the one of the yields corresponding to the one of the future dates immediately preceding the future date corresponding that floating payment,
determining a plurality of fixed payments based on a fixed interest rate,
determining a plurality of terminal values, each of the terminal values corresponding to one of the future dates and representing a compounded return based on the yields corresponding to the future dates preceding the future date corresponding to the terminal value,
determining a discount factor corresponding to each of future dates, each of the discount factors being an inverse of the terminal value corresponding to the same date as the discount factor,
determining a present value for each of the floating payments, each of the floating payment present values corresponding to one of the future dates and representing the product of the floating payment and the discount factor also corresponding to that future date,
determining a present value for each of the fixed payments, each of the fixed payment present values corresponding to one of the future dates and representing the product of the fixed payment and the discount factor also corresponding to that future date,
generating a quote for a swap index futures contract as a function of the present values of the floating payments and the present values of the fixed payments, wherein the swap index futures contract has standard terms and price as the only trading variable,
processing a plurality of bids and a plurality of offers for the swap index futures contract in response to the quote, and
matching at least one of the bids and at least one of the offers to execute a trade for the swap index futures contract.

11. The apparatus of claim 10, wherein the generating comprises determining a sum of the present values of the floating payments, determining a sum of the present values of the fixed payments, and subtracting one of the sums from the other of the sums to obtain a subtraction result, and then subtracting the subtraction result from a fixed value.

12. The apparatus of claim 10, wherein a first of the yields differs from a second of the yields.

13. The apparatus of claim 10, wherein the receiving comprises receiving settlement values for Eurodollar futures contracts maturing on each of the multiple future dates.
